(19) United States
(12) Patent Application Publication
(10) Pub. No.: US 2026/0203915 A1
(43) Pub. Date: Jul. 16, 2026

(54) TRAJECTORY ESTIMATION USING AN IMAGE SEQUENCE

(71) Applicant: FARO Technologies, Inc., Lake Mary, FL (US)

(72) Inventor: Jafar Amiri Parian, Schlieren (CH)

(21) Appl. No.: 19/441,040

(22) Filed: Jan. 6, 2026

Related U.S. Application Data
(63) Continuation of application No. PCT/US24/44444, filed on Aug. 29, 2024.
(60) Provisional application No. 63/579,339, filed on Aug. 29, 2023.

(51) Int. Cl. G06T 7/246; G06T 7/73; G06V 20/40

(52) U.S. Cl. CPC G06T 7/248; G06T 7/74; G06V 20/46; G06V 20/48; G06T 2207/30241

(57) ABSTRACT

Examples described herein provide a method for trajectory estimation using an image sequence. The method includes receiving an image sequence of an environment from a camera moving relative to the environment. The method further includes extracting and matching features from images of the image sequence. The method further includes determining a relative orientation of the images of the image sequence. The method further includes determining orientation parameters of the camera using sequential image resection. The method further includes performing, using the orientation parameters, bundle adjustment to generate refined orientation parameters of the camera. The method further includes estimating a trajectory of the camera relative to the environment based at least in part on the refined orientation parameters by performing loop closure.

### CROSS-REFERENCE TO RELATED APPLICATIONS

This application is a continuation of PCT application Serial No. PCT/US24/44444, filed on Aug. 29, 2024 entitled “Trajectory Estimation Using An Image Sequence,” the contents of which are incorporated herein by reference in their entirety, and this application claims the benefit of U.S. Provisional Application Ser. No. 63/579,339 filed on Aug. 29, 2023 entitled “Trajectory Estimation Using An Image Sequence,” the contents of which are incorporated herein by reference in their entirety.

### BACKGROUND

The subject matter disclosed herein relates to trajectory estimation, and in particular, relates to estimating the trajectory of a three-dimensional measurement device that is moving through and or relative to an environment.

Processing systems (e.g., smartphones, laptop computers, tablet computers, wearable computing devices, and/or the like including combinations and/or multiples thereof) include a sensor (e.g., a camera) for capturing images, such as of an object or environment. In some cases, the images are processed, analyzed, or otherwise used for some purpose, such as to measure environments or objects. For example, photogrammetry is a technique for measuring objects using images, such as photographic images acquired by a camera or other suitable sensor of a processing system. Photogrammetry is used to make three-dimensional (3D) measurements from two-dimensional (2D) images or photographs. In some cases, photogrammetry involves determining 3D coordinates using triangulation based at least in part on common features or landmarks between two images.

Accordingly, while existing three-dimensional measurement systems are suitable for their intended purposes, a system having improved features is introduced herein.

### BRIEF DESCRIPTION

In some embodiments, a method for trajectory estimation using an image sequence is provided. The method includes receiving an image sequence of an environment from a camera moving relative to the environment. Features from images of the image sequence are extracted and matched. A relative orientation of the images of the image sequence is determined. Orientation parameters of the camera are determined using sequential image resection. Bundle adjustment is performed, using orientation parameters, to generate refined orientation parameters of the camera. A trajectory of the camera is estimated relative to the environment based at least in part on the refined orientation parameters by performing loop closure.

In some embodiments, a system is provided that includes a camera to capture an image sequence of an environment as the camera moves relative to the environment. A processing system is provided that communicatively coupled to the camera. The processing system includes a memory that stores computer readable instructions, and a processing device for executing the computer readable instructions. The computer readable instructions include: extracting and matching features from images of the image sequence; determining a relative orientation of the images of the image sequence; determining orientation parameters of the camera using sequential image resection; performing, using the orientation parameters, a bundle adjustment to generate refined orientation parameters of the camera; and estimating a trajectory of the camera relative to the environment based at least in part on the refined orientation parameters after performing loop closure.

The above features and advantages, and other features and advantages, of the disclosure are readily apparent from the following detailed description when taken in connection with the accompanying drawings.

### BRIEF DESCRIPTION OF DRAWINGS

The foregoing and other features and advantages of one or more embodiments described herein are apparent from the following detailed description taken in conjunction with the accompanying drawings in which:

FIGS. 1A-1C depict a system for collecting and/or displaying images of an environment according to one or more embodiments described herein;

FIGS. 1D-IF depict images associated with the system of FIGS. 1A-1C;

FIG. 2 is a schematic illustration of a processing system for trajectory estimation using an image sequence according to one or more embodiments described herein;

FIG. 3 is a flow diagram of a method for trajectory estimation using an image sequence according to one or more embodiments described herein;

FIG. 4 is a flow diagram of a method for loop closure for trajectory estimation according to one or more embodiments described herein; and

FIG. 5 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

Embodiments described herein provide for trajectory estimation using a sequence of captured images from a mobile camera apparatus that moves in and with respect to an environment of interest. Various embodiments provide advantages in reducing the computational requirements on one or more processors to reduce the time, data storage and bandwidth requirements therefor while determining a reliable and accurate trajectory of the sensors capturing the images.

As used herein, trajectory estimation is a process of accurately determining a path and motion of an object or agent over time, within or relative to a given environment. Trajectory estimation is useful in many fields, such as metrology, robotics, computer vision, aerospace engineering, autonomous systems, and/or the like including combinations and/or multiples thereof. Estimating trajectories is useful for understanding the behavior and dynamics of moving entities, which can provide precise predictions and control in dynamic scenarios.

Trajectory estimation plays a role in a wide range of tasks. In robotics, for example, trajectory estimation is used for robot localization, mapping, and navigation. By accurately estimating a robot's trajectory, the robot can determine its current position, create maps of its surroundings, and plan optimal paths to reach its destination or perform specific tasks. In computer vision, trajectory estimation is often used to track the movement of objects in video sequences, which enables applications like object tracking, surveillance, and activity recognition. In the field of aerospace engineering, trajectory estimation is used for spacecraft and aerial vehicle navigation and control. For example, trajectory estimation is used for maneuvering aircraft/spacecraft, determining orbits, and other tasks that can influence mission success.

Trajectory estimation can be challenging because of various sources of uncertainty and noise, such as sensor inaccuracies, occlusion, environmental changes, dynamic interactions with other objects (e.g., moving objects), and/or the like, including combinations and/or multiples thereof. To address these challenges, various techniques can be employed, such as sensor fusion, probabilistic filtering (e.g., Kalman filtering, particle filtering), machine learning, and optimization methods, among others.

To address various shortcomings in existing technologies, one or more embodiments described herein provide for trajectory estimation using image alignment for an image sequence of captured images. For example, when a camera moves through an environment, the camera captures images as it moves, resulting in an image sequence. The image sequence is used to estimate a trajectory of the movement of the camera through the environment during capture, using one or more of the embodiments described herein.

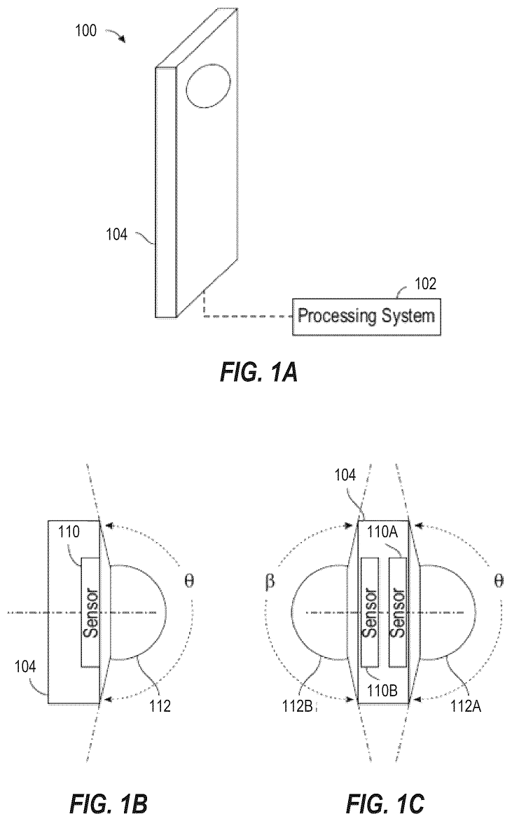

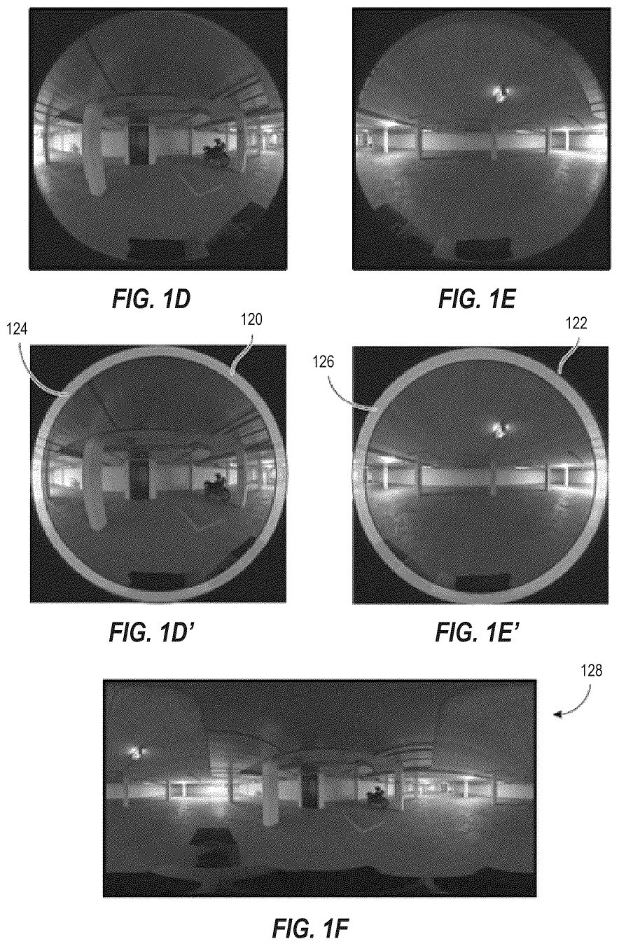

Referring now to FIGS. 1A-1C, an embodiment is shown of a system 100 for collecting and/or displaying images of an environment according to one or more embodiments described herein. Particularly, FIG. 1A depicts the system 100 for collecting and/or displaying images of an environment or object, the system 100 having a camera 104 and a processing system 102.

In some embodiments, the processing system 102 is any suitable processing system, such as a built-in processing unit, a smartphone, tablet computer, laptop or notebook computer, node(s) of a cloud computing system, etc. Although not shown, in some embodiments the processing system 102 includes one or more additional components, such as at least one processor or microprocessors for executing processing instructions, a memory, such as a hard disk drive, random access memory, read-only memory, a memory chip or the like for storing the processing instructions and data in an electronic, computer-readable format, a display for displaying user interfaces, an input device for receiving inputs, an output device for generating outputs, a communications adapter for facilitating communications with other devices (e.g., the camera 104), and the like including combinations and/or multiples thereof.

The camera 104 captures images, such as a panoramic image, of an environment. In examples, the camera 104 is an ultra-wide angle camera. As an example, the camera 104 is an omnidirectional camera, such as the RICO THETA or INSTA360 camera. In an embodiment, the camera 104 includes at least one sensor 110 (FIG. 1B), which, in various embodiments includes an array of photosensitive pixels. The sensor 110 is arranged to receive light from a lens 112. In the illustrated embodiment, the lens 112 is an ultra-wide angle lens that provides (in combination with the sensor 110) a field of view θ between 100 and 270 degrees, for example. In an embodiment, the field of view θ is greater than 180 degrees and less than 270 degrees. It should be appreciated that while embodiments herein describe the lens 112 as a single lens, this is for exemplary purposes and in some embodiments the lens 112 is comprised of a plurality of optical elements.

In some embodiments, the camera 104 includes a pair of sensors 110A, 110B that are arranged to receive light from ultra-wide angle lenses 112A, 112B respectively (FIG. 1C). In this disclosure, the camera 104 is sometimes referred to as a dual camera because it has a pair of sensors 110A, 110B and corresponding lenses 112A and 112B as shown. The sensor 110A and lens 112A are arranged to acquire images in a first direction, and the sensor 110B and lens 112B are arranged to acquire images in a second direction. In the illustrated embodiment, the second direction is opposite the first direction (e.g., 180 degrees apart). A camera having opposingly arranged sensors and lenses with at least a 180 degree field of view is sometimes referred to as an omnidirectional camera, a 360 degree camera, or a panoramic camera, since it acquires an image in a 360 degree volume about at least one axis of the camera.

In an embodiment, the camera 104 is referred to as a “rig photogrammetry system” or simply a “rig” as further described herein. In various embodiments, the camera 104 (e.g., rig) is moved through an environment to capture a plurality of images about a surrounding environment. The plurality of images forms an “image sequence” or “sequence of images” as variously referenced herein. The processing system 102, or another suitable processing system or device, performs photogrammetry methods on the captured images that form the image sequence to generate a 3D representation/model, of the environment in which the images were captured. In some embodiments, it is desirable to estimate the trajectory of the camera 104 as it moves throughout or relative to the environment to facilitate the determination of the 3D representation or model. Various methods for trajectory estimation are further described herein.

FIGS. 1D and 1E depict images acquired by the dual camera of FIG. 1C, for example, and FIGS. 1D′ and 1E′ depict images acquired by the dual camera of FIG. 1C, where each of the images has a field of view greater than 180 degrees. It should be appreciated that when the field of view is greater than 180 degrees, there will be an overlap 120, 122 between the acquired images 124, 126 as shown in FIG. 1D′ and FIG. 1E′. In some embodiments, the images are combined to form a single image 128 of at least a substantial portion of the spherical volume about the camera 104 as shown in FIG. 1F. In various embodiments, more than two such images are captured at each point along a trajectory, and the image sequence captured along the entire trajectory includes hundreds, to tens of thousands of images from one or both of the sensors of the camera 104.

It should be appreciated that in some embodiments the camera 104 is used in a stationary mode, such as on a tripod for example. In other embodiments, the camera 104 is mounted to a fixture, such as a handle for example, and carried by the operator through the environment. In still further embodiments, the fixture includes an elongated arm that allows the camera 104 to be positioned over the users head. In yet still further embodiments, the camera 104 is attached or coupled to the user, such as on the top of a hard-hat for example. In an embodiment, the camera 104 is carried through a building construction site to document work progress.

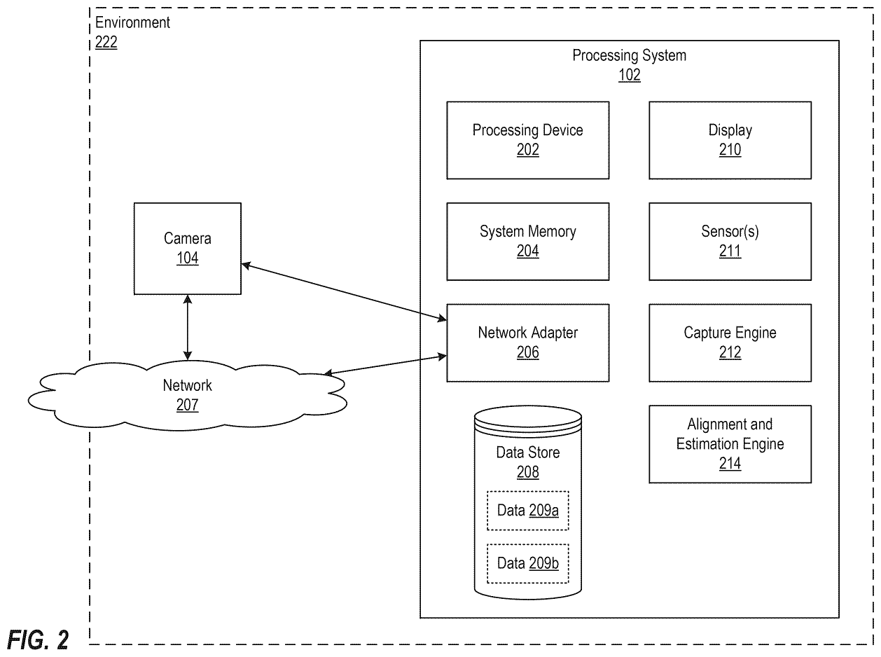

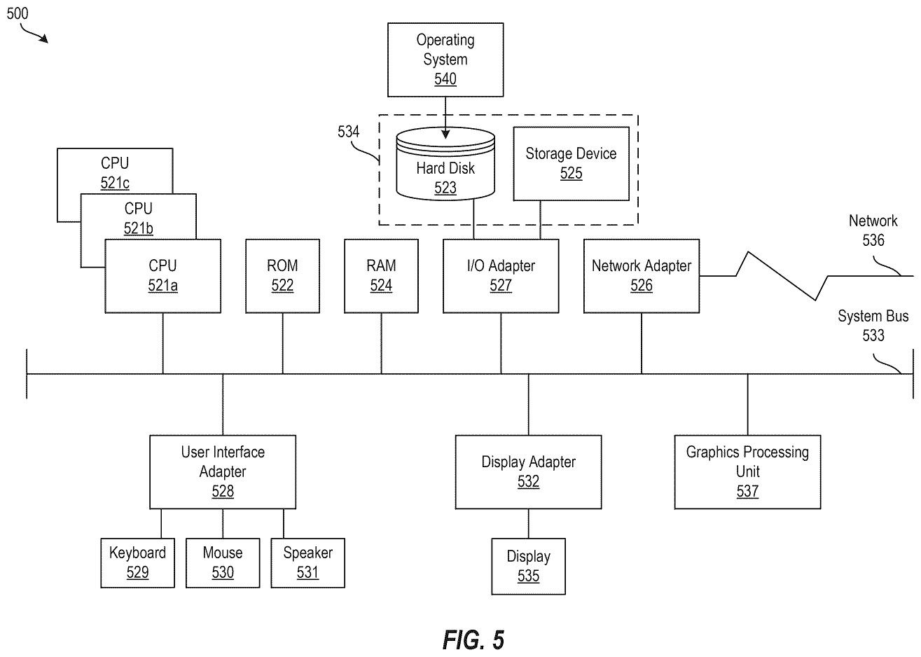

Turning now to FIG. 2, a schematic illustration of one embodiment of the processing system 102 for trajectory estimation using an image sequence is shown. Other useful embodiments are readily contemplated herein. The processing system 102 is any suitable computing device, such as a laptop computer, a desktop computer, a smartphone, a tablet computer, and/or the like, including combinations and/or multiples thereof. According to some embodiments described herein below, FIG. 5 depicts a processing system 500, which is another example of the processing system 102. Returning to FIG. 2, the processing system 102 includes a processing device 202 (e.g., one or more of the processing devices 521 of FIG. 5), a system memory 204 (e.g., the RAM 524 and/or the ROM 522 of FIG. 5), a network adapter 206 (e.g., the network adapter 526 of FIG. 5), a data store 208, a display 210, sensor(s) 211, a capture engine 212, and an alignment and trajectory engine 214.

In various embodiments, the components, modules, engines, etc. described regarding FIG. 2 (such as, the capture engine 212 and the alignment and trajectory engine 214) are implemented as computer processing instructions that are stored on a computer-readable storage medium, in hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein is a combination of hardware and programming. The programming is embodied in processor-executable instructions stored in a tangible memory, and the hardware can include the processing device 202 for executing those instructions. Thus, the system memory 204 stores program instructions that when executed by the processing device 202 implement the engines described herein. Other engines also are utilized to include other features and functionality described in other examples herein. In some embodiments, the network adapter 206 enables the processing system 102 to transmit data to and receive data from other sources, such as the camera 104.

In various embodiments, the camera 104 is any suitable device for collecting images of an object or an environment 222. For example, the processing system 102 receives data (e.g., an image or set of images of the environment 222) from the camera 104 directly and via a wired or wireless network 207. The data (e.g., image(s)) from the camera 104) is stored in the data store 208 of the processing system 102 as data 209a (also referred to as “images 209a”). According to some embodiments described herein, the capture engine 212 causes the camera 104 to capture the data 209a (e.g., images), such as by transmitting an activation signal to the camera 104. According to some embodiments described herein, the camera 104 captures the data 209a automatically and transmits the data 209a to the processing system 102 for processing and/or storage. In other embodiments, the camera 104 captures the data 209a in response to a trigger event (e.g. a user command) and transmits the data 209a to the processing system 102 for processing and storage.

According to some embodiments described herein, the capture engine 212 uses the sensor(s) 211 to capture additional data and images of the environment 222 as data 209b. According to some embodiments described herein, the processing system 102 generates a representation of the data 209a and the data 209b as a point cloud, which is displayed on the display 210. The sensor(s) 211 include at least one sensor for capturing data/information about the environment 222. The sensor(s) 211 can include one or more of the following: a camera, an omnidirectional camera, a panoramic camera, a 360-degree camera, a LIDAR sensor, and the like, including combinations and multiples thereof.

The network 207 represents at least one types of suitable communications network such as, for example, cable networks, public networks (e.g., the Internet), private networks, wireless networks, cellular networks, or any other suitable private and/or public networks. Further, the network 207 can have any suitable communication range associated therewith and include, for example, global networks (e.g., the Internet), metropolitan area networks (MANs), wide area networks (WANs), local area networks (LANs), or personal area networks (PANs). In addition, the network 207 can include any type of medium over which network traffic is carried including, but not limited to, coaxial cable, twisted-pair wire, optical fiber, a hybrid fiber coaxial (HFC) medium, microwave terrestrial transceivers, radio frequency communication mediums, satellite communication mediums, and any combination thereof.

During image capture, the camera 104 is arranged on, in, and around the environment 222 to collect data/images of the environment 222. For example, the camera 104 captures a sequence of images of the environment while moving along a path.

According to some embodiments described herein, using images (e.g., the data 209a) received from the camera 104 and the images (e.g., the data 209b) captured by the sensor(s) 211, the processing system 102 performs various photogrammetry functions. Photogrammetry is a technique for modeling objects using images, such as photographic images acquired by a digital camera. Photogrammetry can make three-dimensional (3D) models from two-dimensional (2D) images and photographs. When at least two images are acquired at different positions that have an overlapping field of view, common points or features (sometimes referred to herein with respect to “tie points”) are identified in each image. By projecting a ray from the camera location to the feature/tie point on the object, the 3D coordinate of the feature/point is determined using trigonometry/triangulation in various embodiments. In some examples, photogrammetry is based on markers/targets (e.g., lights or reflective stickers) placed on an object in the environment. In other embodiments, the photogrammetry is based on distinctive natural features thereof. To perform photogrammetry, in various instances, images are captured, with a camera having at least one sensor (such as a photosensitive array for example). By acquiring multiple images of an object, or a portion of the object, from different positions or orientations, 3D coordinates of points on the object are determined based on common features or points and information on the position and orientation (e.g., pose, or pitch, yaw, and roll angle) of the camera when each image is acquired. In order to obtain the desired information for determining 3D coordinates, the features are identified in at least two. Since the images are acquired from different positions or orientations, the common features are located in overlapping areas of the field of view of the images. It should be appreciated that one method of performing photogrammetry techniques is described in commonly-owned U.S. Pat. No. 10,477,180 entitled “PHOTOGRAMMETRY SYSTEM AND METHOD OF OPERATION” filed in the name of Wolke et al., the contents of which are incorporated by reference herein. With photogrammetry, at least two images are captured and used to determine 3D coordinates of features.

One approach to photogrammetry, variously referred to as rig photogrammetry, is an approach in photogrammetry where multiple cameras (see, e.g., FIGS. 1A-1C) are fixed or rigidly mounted in a predetermined configuration to capture images of an object or environment from different viewpoints simultaneously. In some examples rig photogrammetry is referred to as static photogrammetry and fixed camera photogrammetry. Rig photogrammetry uses the overlapping views from multiple fixed cameras to reconstruct the 3D structure of an object and environment accurately. In an embodiment, rig photogrammetry stitches two of the images of the fixed cameras into a single combined image.

In an embodiment, the rig setup in photogrammetry includes multiple cameras arranged in a predetermined geometric configuration, such as shown in FIGS. 1A-1C. Different configurations are possible, such as a linear configuration, a circular configuration, a back-to-back configuration, and the like including combinations and multiples thereof. The particular arrangement of cameras is selected to provide a desired overlap and coverage of the object and environment being captured. In some embodiments, the cameras have the same focal lengths and resolutions. In other embodiments, the cameras have different focal lengths and resolutions depending on the specific aspects of the photogrammetric task to be performed.

Rig photogrammetry is used in various applications, such as for 3D modelling and reconstruction. In some cases, rig photogrammetry is used for trajectory estimation using 360° panorama images generated using fisheye images or directly using a rig of dual fisheye images. For example, a rig photogrammetry system, such as the camera 104 of FIGS. 1A-1C, is used to collect images (e.g., 360° panorama images) over time as the rig photogrammetry system moves through an environment. The processing system 102 then uses the images to estimate a trajectory of the rig photogrammetry system, which indicates where the rig photogrammetry system moved through the environment as it collected images for the sequence of images.

Rig photogrammetry provides the ability to capture multiple views simultaneously, which reduces the time required for data acquisition, especially in scenarios where the object, the environment, or captures thereof are dynamic (e.g., might include changes from rapid movements of transitory objects in the field of view). Additionally, the fixed camera configuration provides consistent camera poses, leading to more accurate and robust 3D reconstruction results. A skilled artisan readily appreciates that the complexity of the setup and the systems and camera calibration processes for multiple cameras is more complex than using a single mobile camera. Embodiments for calibrating a system for rig photogrammetry including a camera calibration and/or a rig setup calibration will now be described.

Calibrating a rig photogrammetry system involves determining intrinsic parameters (e.g., camera calibration) and the relative orientation of the cameras in the rig. This calibration process provides for accurately reconstructing the 3D structure of the environment or object from the images captured by the multiple fixed cameras as it moves along a path whose trajectory is not measured directly by a global positioning system (GPS) or the like, thereby reducing the costs thereof.

Camera calibration is performed for each individual camera in the rig to determine its intrinsic parameters. Examples of intrinsic parameters can include focal length, principal point, lens distortion coefficients, skew, aspect ratio, and/or the like including combinations and/or multiples thereof. Camera calibration is performed using on-the-fly calibration in which no additional data is obtained before or after the image capture. Common points produced through feature extraction and matching in images involving the same location in an environment or on an object, as described herein, can be used in this process. Each camera of the rig is calibrated individually by using the portion of an image set selected for camera calibration. A number of common features and root mean squares of errors (RMSE) of bundle adjustment, as described herein, is considered for image candidates. To obtain enough common points suitable for camera calibration, and to have a sufficiently large base line among the camera poses, the cameras of the rig can be arranged orthogonally to the direction of movement.

Once the intrinsic parameters of each camera of the rig are computed, the relative orientations of the cameras in the rig is determined. This involves finding the translation and rotation between the cameras' coordinate systems. The relative orientation calibration is performed using a calibration object with known 3D points. This object is placed within the environment (e.g., the environment 222), and the 3D points of the object are captured in the images from each camera. By matching the 3D points in the images, the relative pose between the cameras is computed.

According to some embodiments described herein, another approach to relative orientation calibration is based on an on-the-fly system calibration. This approach uses common image points of the images of the image sequence and is applied to applications like trajectory estimation, where scale information is not being used.

According to one or more embodiments described herein, in some setup configurations, existing information can be used as a constraint to increase the reliability of system calibration. The existing information is, for example, back-to-back camera placement (when the distance between the two camera positions is unknown) in camera systems such as those shown and described herein (see, e.g., FIGS. 1A-1C) and the like including combinations and multiples thereof. The distance of the two cameras is unknown, for example, because an accurate distance is unknown in advance. System calibration, as described herein, is used to determine this unknown distance as well as certain other unknown parameters.

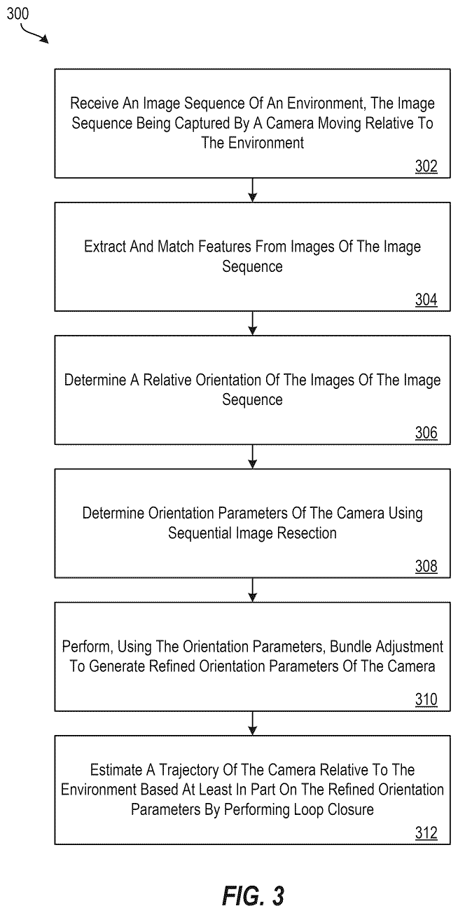

With continued reference to FIG. 2, according to one or more embodiments described herein, using images (e.g., the data 209a or 209b) received from the camera 104 and the images as captured by the sensor(s) 211, the processing system 102 performs trajectory estimation using an image sequence using the alignment and trajectory engine 214. Trajectory estimation is now described in more detail with reference to FIG. 3.

According to one or more embodiments described herein, the alignment and trajectory engine 214 performs image alignment, which is used for trajectory estimation. Image alignment is the process of determining the camera location and camera angular orientation with respect to a reference coordinate system. Image alignment is a pre-requisite for an accurate reconstruction of a scene in 3D space in various embodiments.

The alignment and trajectory engine 214 performs at least one technique for image alignment in photogrammetry, such as feature-based matching, direct image alignment sequential alignment, bundle adjustment, global positioning systems (GPS) and control points, and the like, including combinations and multiples thereof.

Feature-based matching involves identifying and matching distinctive features in different images. These features include key points, corners, or other salient points (i.e., tie points) that are easily detected and described. Once the features are matched across the images, the alignment and trajectory engine 214 calculates the transformation (e.g., translation, rotation) to align the images.

Sequential image alignment involves aligning images sequentially, where the images that are already oriented serve as a reference, and subsequent images are aligned to the reference.

Bundle adjustment is an optimization technique used to simultaneously refine the camera parameters and 3D coordinates of points in the scene. In such an approach, the alignment and trajectory engine 214 considers multiple images and features together, which provides for a consistent and accurate alignment by reducing or minimizing reprojection error, which is the difference between the observed image points and the projected 3D points.

GPS and control points, if available and depending on their accuracy, provides an initial image alignment. For example, the alignment and trajectory engine 214 can use GPS coordinates and ground control points (GCPs) to perform an initial alignment following the georeferencing of the images and the entire photogrammetry network.

It should be appreciated that image alignment is a computationally intensive process, especially when dealing with a large number of images and complex scenes. Therefore, in some embodiments, software and libraries that implement efficient algorithms for image alignment are used.

In an embodiment, trajectory estimation is performed using an image sequence, which is now described with reference to FIG. 3. Particularly, FIG. 3 depicts a flow diagram of a method 300 for trajectory estimation using an image sequence according to some embodiments described herein. The method 300 is performed by any suitable system or device, such as the processing system 102 of FIG. 1A, the processing system 102 of FIG. 2, and/or the processing system 500 of FIG. 5. FIG. 3 is now described in more detail with reference to FIG. 2 but is not so limited.

At block 302, the processing system 102 receives an image sequence of an environment (e.g., the environment 222), such as from the camera 104 for example. The image sequence includes multiple images captured by the camera moving relative to the environment.

At block 304, the alignment and trajectory engine 214 performs extraction and feature matching on various of the images of the image sequence. For example, the alignment and trajectory engine 214 performs scale-invariant feature transform (SIFT), oriented FAST (features from accelerated segment test) and rotated BRIEF (binary robust independent elementary features) (ORB), and another suitable techniques for extracting features. Once extracted, the features are matched between, for example, two images based on descriptors of the extracted features. Examples of techniques for extracting features and descriptors are described in co-owned U.S. Patent Publication No. US 2022/0414925 entitled “TRACKING WITH REFERENCE TO A WORLD COORDINATE SYSTEM, filed in the name of Parian et al., which is incorporated by reference here in its entirety.

At block 306, the alignment and trajectory engine 214 determines the relative orientation of the images (e.g., two images) of the image sequence. The relative orientation of two images refers to the process of determining the spatial relationship between the two images taken from different viewpoints. More particularly, relative orientation involves estimating the relative position and orientation (e.g., translation and rotation, or pose) of one camera and position thereof with respect to another camera and position thereof. The alignment and trajectory engine 214 performs the relative orientation process using feature-based matching techniques, where distinctive features (e.g., keypoints, corners, edges, and/or the like including combinations and/or multiples thereof) in both images are detected and matched, in various embodiments. These features act as correspondence points between the two images.

In embodiments where the cameras have known internal calibration parameters (e.g., focal length, principal point), a fundamental matrix can be converted into an essential matrix. The essential matrix contains the information used to recover the relative rotation and translation between the cameras, for example, up to an unknown scale factor. The relative rotation and translation are extracted from the essential matrix using decomposition techniques, such as singular value decomposition (SVD).

According to some embodiments described herein, the alignment and trajectory engine 214 also determines the scale of the relative orientation. In an embodiment, this is achieved using additional information, such as ground control points or known object dimensions. In embodiments where scale information is unavailable, the scale is set to an arbitrarily value.

Once the relative orientation is established, the images are accurately aligned through bundle adjustment, and sparse 3D points are estimated as well, as is now further described.

At block 308, the alignment and trajectory engine 214 determines orientation parameters of the camera using sequential image resection. Sequential image resection (also known as resectioning, image space resection, and camera resection) is a photogrammetric technique used to determine the orientation parameters (e.g., exterior orientation parameters) of a camera (e.g., the camera 104), such as position and orientation, in an image coordinate system. Camera resectioning is a process of estimating parameters of a camera model approximating the camera that produced a given photograph or video that determines which incoming light ray is associated with each pixel on a given image. In various embodiments, the process determines the pose of the camera. Typically, the camera parameters are represented in a 3×4 projection matrix called the camera matrix. The extrinsic parameters define the camera pose (position and orientation) while the intrinsic parameters define the camera image format (focal length, pixel size, and image origin). This process is often called geometric camera calibration. In some embodiments, the process is also simply called camera calibration. It should be appreciated that in some examples, to those of skill in the art, the term “camera calibration” refers to photometric camera calibration. In other examples, camera calibration is restricted for the estimation of the intrinsic parameters only. Exterior orientation and interior orientation refer to the determination of only the extrinsic and intrinsic parameters, respectively. Camera resectioning is useful in the application of stereo vision where the camera projection matrices of two cameras are used to calculate the 3D world coordinates of a point viewed by both cameras.

By performing sequential image resection, the alignment and trajectory engine 214 estimates the location and orientation of the camera relative to the environment being photographed. The image resection provides for identifying the position of the projection center of the camera (which can be referred to as the perspective center of the camera) and the orientation of the camera in terms of roll, pitch, and yaw angles. Together, these values are referred to as the exterior orientation parameters. Once these exterior orientation parameters are known, a viewpoint of the camera is accurately positioned in the 3D scene representative of the environment (e.g., the environment 222).

In some embodiments, the alignment and trajectory engine 214 also performs triangulation, which is the process of reconstructing the 3D coordinates of points in the real world from multiple 2D images taken from different viewpoints. The principle behind photogrammetry triangulation is based on the intersection of visual rays, which are lines connecting the perspective center of the camera with the corresponding points in the images. When multiple images of the same point are available, these visual rays intersect at a 3D point, allowing the determination of its position in the real world. Once triangulation is performed, more 3D points are generated, and more images are passed to be resectioned. The process of image space resection and triangulation is repeated until the desired images of the image sequence are oriented.

According to one or more embodiments described herein, the step 304 is performed for at least a portion images one time. In an embodiment, step 304 is performed on all of the images. The step 306 is performed until a pair of images are successfully oriented. In various embodiments the number of images ranges from tens, to hundreds, to thousands of images. The steps performed at blocks 308 and 310 are performed iteratively for additional un-oriented images. Throughout the iterative steps at blocks 308 and 310, the orientation of more images is determined.

At block 310, the alignment and trajectory engine 214 uses the orientation parameters to perform bundle adjustment to generate refined orientation parameters of the camera. Bundle adjustment is a global optimization technique used to refine the camera parameters (e.g., intrinsic parameters and extrinsic parameters) and 3D coordinates of points in a photogrammetric reconstruction. Bundle adjustment simultaneously optimizes camera poses and 3D points to reduce the differences between the observed image points and the corresponding 3D points.

Bundle adjustment is a process for simultaneous refining of 3D coordinates describing the scene geometry, the parameters of the relative motion, and the optical characteristics of the camera(s) employed to acquire the images, given a set of images depicting a number of 3D points from different viewpoints. Its name refers to the geometrical bundles of light rays originating from each 3D feature and converging on each camera's optical center, which are optimally adjusted according to an optimality criterion involving the corresponding image projections of all points.

In some embodiments, bundle adjustment is used as the last step of feature-based 3D reconstruction algorithms. It amounts to an optimization problem on the 3D structure and viewing parameters (i.e., camera pose and possibly intrinsic calibration and radial distortion), to obtain a reconstruction which achieves a desired threshold (e.g. optimal) under certain assumptions regarding the noise pertaining to the observed image features.

Bundle adjustment reduces or minimizes the reprojection error between the image locations of observed and predicted image points, which is expressed as the sum of squares of a large number of nonlinear, real-valued functions. Thus, the minimization is achieved using nonlinear least-squares algorithms, such as but not limited to Levenberg-Marquardt algorithms. By iteratively linearizing the function to be reduced/minimized in the neighborhood of the current estimate, the algorithm involves the solution of linear systems. When solving the minimization problems arising in the framework of bundle adjustment, the normal equations have a sparse block structure owing to the lack of interaction among parameters for different 3D points and cameras. This can be exploited to gain improved computational benefits by employing a sparse variant of the algorithm which explicitly takes advantage of the normal equations zeros pattern, avoiding storing and operating on zero-elements thereof.

In photogrammetry, after performing image resection (block 306), a sparse point cloud is obtained. The sparse point cloud is a result of the align step, where tie points are used and at first distortion parameters and camera positions are unknown. A sparse cloud is a collection of points that represent the position and orientation of the features that are common in multiple images. A sparse cloud is usually generated by matching key points, which are distinctive points in each image, such as tie points, corners or edges. A sparse cloud is different from a dense cloud, which is a collection of points that cover substantially the entire surface of the object or scene. A dense cloud is usually generated by estimating the depth of each pixel in the images using stereo matching or multi-view stereo techniques. The sparse point cloud points are tie points where each point corresponds to a feature that was identified in more than one photo, and deemed to be a valid match. Dense cloud points are subsequently calculated by rectifying image pairs such that epipolar lines become parallel (the transformation is dependent on camera orientation parameters that were derived from the tie points) and then a different algorithm can be used to match pixels to pixels in these image pairs.—The alignment and trajectory engine 214 perform bundle adjustment iteratively (combined with steps 308 and 310) to improve the accuracy of the entire trajectory and 3D points of the sparse point cloud.

Bundle adjustment for large data sets (e.g., more than about 500 images) is time consuming and demands significant computer memory and processing resources. According to some embodiments described herein, the bundle adjustment employed is an incremental bundle adjustment. Incremental bundle adjustment provides for performing bundle adjustment on a subgroup of images for an existing data set.

Consider the following example where a data set of about 900 images exists. When new images (for example, 50 new images) are obtained, the incremental bundle adjustment is performed to fine-tune the new images to the existing oriented images. Incremental bundle adjustment, in various embodiments, takes advantage of alignment information of the initial data set (e.g., the 900 images data set) to further improve speed in aligning the new images and to reduce demands on computer memory and processing resources. In some embodiments, where the number of new images is less than a threshold (e.g., 200 new images), camera calibration parameters is estimated together with (incremental) bundle adjustment.

At block 312, the alignment and trajectory engine 214 estimates a trajectory of the camera relative to the environment based at least in part on the refined orientation parameters. This includes performing loop closure. In the context of camera localization and mapping, for example, loop closure refers to the process of detecting and correctly associating previously visited locations, positions, and places in the camera's environment. This occurs when a mobile camera system revisits a location the system has been to before during its exploration or navigation within the environment 222. Loop closure is useful for accurate and consistent mapping and localization, particularly in long-term robotic operations where errors in position estimates can accumulate over time (sometimes referred to as drift). When the camera 104 moves through the environment 222, loop closure is performed to detect and associate previously visited (e.g., captured) locations or places within the environment, thereby yielding greater accuracy and consistency in trajectory estimation of the camera 104. It should be appreciated that in some embodiments loop closure is also performed on manually acquired scans, such as when a user holds a three-dimensional coordinate measurement device and walks through the environment 222.

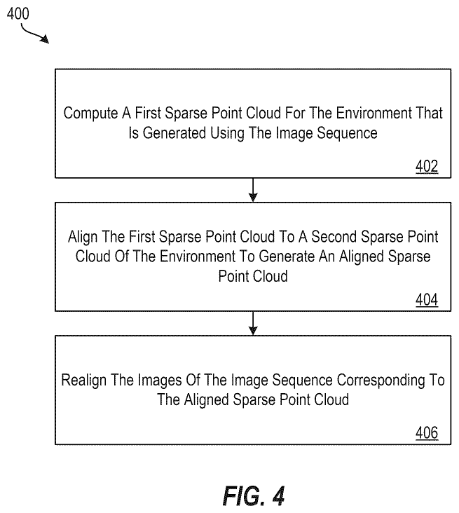

According to some embodiments described herein, a method is performed to accurately realign the images and close any gap in the trajectory of the camera, so as to reduce drift in the trajectory of the camera 104. For example, FIG. 4 depicts a flow diagram of method 400 for loop closure for trajectory estimation according to some embodiments described herein.

At block 402, the alignment and trajectory engine 214 computes a first sparse point cloud for the environment that is generated using the image sequence. At block 404, the alignment and trajectory engine 214 aligns the first sparse point cloud to a second sparse point cloud of the environment to generate an aligned sparse point cloud. At block 406, the alignment and trajectory engine 214 realigns the images of the image sequence corresponding to the aligned sparse point cloud.

In an embodiment, this process is iteratively repeated for many sparse point clouds from many related images to create a dense point cloud relating to the environment 222.

According to some embodiments described herein, for more than two sparse point clouds (e.g., generated from a portion of the image sequence), the other sparse point clouds are aligned simultaneously through the least squares optimization. The points in the sparse point cloud have their own unique identifier (ID). These IDs are used to find corresponding points used for point cloud alignment and point cloud registration. Once the sparse point clouds are aligned, the alignment parameters are applied to the image sequence, which is used to generate these sparse points.

It should be understood that the methods 300 and/or 400 depicted in FIGS. 3 and 4 represent illustrations, and that in other embodiments other processes are added or existing processes are removed, modified, and rearranged without departing from the scope of the present disclosure.

An exemplary image alignment and trajectory estimation process is summarized in the following table:

TABLE 1
Image alignment/trajectory estimation

| IA | |
|---|---|
| 1 | Video is processed and best keyframes (images) are extracted |
| 2 | n images are available from step 1 |
| | initialize fullBundle = true |
| 3 | Photogrammetry relative image orientation is performed through image pairs. |
| | Image pairs are the combination of images of step 2. |
| 4 | If relative orientation is not successful, there is no solution. Go to step 12. |
| 5 | If relative orientation is successful, perform bundle adjustment for fine-tuning |
| | the images' orientation parameters (EOPs). |
| 6 | By using the 3D points, perform space resection of an unaligned image. Then |
| | perform forward intersection and compute 3D coordinates of common points |
| | among all oriented images. |
| 6a | If fullBundle is true go to step 7 otherwise go to step 10. |
| 7 | Repeat step 6, if the number of newly oriented images is less than m. m is a |
| | number in the range of 4-100, for example, m is 20. |
| | If the total number of oriented images is less than p and the number of newly |
| | oriented images is larger than m or step 6 was done for all images go to step 8 |
| | otherwise, go to step 9 |
| 8 | Perform bundle adjustment for these m images and fine-tune the EOPs as well |
| | as the camera calibration parameters. Continue to step 6. |
| 9 | Set the value of fullBundle = false and go to step 10 |
| 10 | Repeat step 6 of all unaligned images until the number of newly oriented |
| | images is less than k. k is a number in the range of 10-200, for example, k is |
| | 40. |
| | If the number of newly oriented images becomes larger than k or step 6 was |
| | done for all images, then go to step 11. |
| | If there are no newly oriented images go to step 12. |
| 11 | Perform bundle adjustment (fine-tune only EOPs of images) for only the |
| | newly oriented images (k). |
| | In this form of bundle adjustment, the EOPs of the previously oriented images |
| | are fixed and only the EOPs of the new images (k) are fine-tuned. We call it |
| | incremental bundle adjustment because it only applies the bundle adjustment |
| | to the new images not the entire sets of images, while the entire set of images |
| | is still contributing to bundle adjustment as constraints. |
| 12 | End of the process |

An exemplary loop closure process is illustrated in the following table:

TABLE 2
Loop closure by rigid body transformation

| LC | |
|---|---|
| 1 | Store the m and k number images in a container. m and k images were found |
| | through the image alignment algorithm at steps IA-7 and IA-10 (Table 1). |
| 2 | Through step 1, a list of grouped images is constructed like the following: |
| | v1: {1, 2, 3, 4, 5, 6, . . . , 20} |
| | v2: {21, 22, 23, 24, 25, 26, . . . , 40} |
| | v3: {41, 42, 43, 44, 45, 46, . . . , 60} |
| | . . . |
| | v50: {1000, 1001, 1002, . . . , 1040} |
| | For example, v1 is the first grouped image and contains image numbers |
| | 1, 2, 3, 4, 5, 6, . . . , 20. |
| 3 | Repeat the following for all grouped images: |
| | Perform the forward intersection by using only the data available from the |
| | grouped images and storing the computed 3D points in a container. All points |
| | computed through this step form a rigid body. |
| 4 | Through step 3, a list of rigid bodies is like the following: |
| | S1: {p1, p3, p5, p8, p9, . . . , p45} |
| | S2: {p12, p13, p5, p8, p9, . . . , p45} |
| | S50: {p1200, p1300, p5, p8, p9, . . . , p4050} |
| | For example, S1 is a rigid body which contains 3D points with labels: p1, p3, |
| | p5, p8, p9, . . . , p45. |
| 5 | Perform 3D conformal transformation (rigid body transformation with 7 |
| | parameters) of all the rigid bodies. A similar approach like ICP is used here |
| | with the difference that corresponding points are available and there is no |
| | need to search for the nearest point to a surface. |
| 6 | Through step 5, rigid body transformation parameters are estimated. |
| 7 | Apply the estimated rigid body transformation parameters to the image |
| | positions of step 2 and compute new EOPs. |
| 8 | Replace the image EOPs with the computed EOPs from step 7. |
| 9 | End |

An exemplary on the fly camera calibration process is summarized in the following table:

TABLE 3
On-the-fly camera calibration for rig-photogrammetry

| CA | |
|---|---|
| 1 | Video is processed and best keyframes (images) are extracted |
| 2 | n images are available from step 1. |
| | initialize fullBundle = true |
| 2a | Among the n image of step 2, keep only the images of one camera. |
| 3 | Photogrammetry relative image orientation is performed through image pairs. |
| | Image pairs are the combination of images of step 2. |
| 4 | If relative orientation is not successful, there is no solution. Go to step 12. |
| 5 | If relative orientation is successful, perform bundle adjustment for fine-tuning |
| | the images' orientation parameters (EOPs). |
| 6 | By using the 3D points, perform space resection of an unaligned image. Then |
| | perform forward intersection and compute 3D coordinates of common points |
| | among all oriented images. |
| 7 | Repeat step 6, if the number of newly oriented images is less than m. m is a |
| | number in the range of 4-100, for example, m is 20. |
| | If the total number of oriented images is less than p and the number of newly |
| | oriented images is larger than m or step 6 was done for all images go to step 8 |
| | otherwise, go to step 9 |
| 8 | Perform bundle adjustment for these m images and fine-tune the EOPs as well |
| | as the camera calibration parameters. Continue to step 6. |
| 9 | End |

In various embodiments, camera calibration is performed by a user holding a dual camera such that the optical axis of each lens of the camera 104 is orthogonal to the walking direction or direction of movement.

It is understood that one or more embodiments described herein is capable of being implemented in conjunction with any other type of computing environment now known or later developed. For example, FIG. 5 depicts a block diagram of a processing system 500 for implementing the techniques described herein. In accordance with one or more embodiments described herein, the processing system 500 is an example of a cloud computing node of a cloud computing environment. In examples, processing system 500 has at least one central processing unit (“processors” or “processing resources” or “processing devices”) 521a, 521b, 521c, etc. (collectively or generically referred to as processor(s) 521 and/or as processing device(s)). In aspects of the present disclosure, each processor 521 includes a reduced instruction set computer (RISC) microprocessor. Processors 521 are coupled to system memory (e.g., random access memory (RAM) 524) and various other components via a system bus 533. Read only memory (ROM) 522 is coupled to system bus 533 and includes a basic input/output system (BIOS), which controls certain basic functions of processing system 500.

Further depicted are an input/output (I/O) adapter 527 and a network adapter 526 coupled to system bus 533. In some embodiments, the I/O adapter 527 is a small computer system interface (SCSI) adapter that communicates with a hard disk 523 and/or a storage device 525 or any other similar component. I/O adapter 527, hard disk 523, and storage device 525 are collectively referred to herein as mass storage 534. In some embodiments, the operating system 540 for execution on processing system 500 are stored in mass storage 534. The network adapter 526 interconnects system bus 533 with an outside network 536 enabling processing system 500 to communicate with other such systems.

A display (e.g., a display monitor) 535 is connected to system bus 533 by display adapter 532, which included a graphics adapter to improve the performance of graphics intensive applications and a video controller. In one aspect of the present disclosure, adapters 526, 527, and/or 532 are connected to at least one I/O buss that is connected to system bus 533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 533 via user interface adapter 528 and display adapter 532. In some embodiments, a keyboard 529, mouse 530, and speaker 531 are interconnected to system bus 533 via user interface adapter 528, which includes, for example, a Super I/O chip integrating multiple device adapters into a single integrated circuit.

In some aspects of the present disclosure, processing system 500 includes a graphics processing unit 537. Graphics processing unit 537 is a specialized electronic circuit designed to manipulate and alter memory to accelerate the creation of images in a frame buffer intended for output to a display. In general, graphics processing unit 537 is very efficient at manipulating computer graphics and image processing, and has a highly parallel structure that makes it more effective than general-purpose CPUs for algorithms where processing of large blocks of data is done in parallel.

Thus, as configured herein, processing system 500 includes processing capability in the form of processors 521, storage capability including system memory (e.g., RAM 524), and mass storage 534, input means such as keyboard 525 and mouse 530, and output capability including speaker 531 and display 535. In some aspects of the present disclosure, a portion of system memory (e.g., RAM 524) and mass storage 534 collectively store the operating system 540 to coordinate the functions of the various components shown in processing system 500.

It will be appreciated that one or more embodiments described herein are embodied as a system, method, or computer program product and take the form of a hardware embodiment, a software embodiment (including firmware, resident software, micro-code, etc.), and a combination thereof. Furthermore, some embodiments described herein take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the embodiment(s) may include only some of the described aspects. Accordingly, the disclosure is not to be seen as limited by the foregoing description, but is only limited by the scope of the appended claims.

What is claimed is:

1. A computer-implemented method for trajectory estimation using an image sequence, the method comprising:
receiving an image sequence of an environment from a camera moving relative to the environment;
extracting and matching features from images of the image sequence;
determining a relative orientation of the images of the image sequence;
determining orientation parameters of the camera using sequential image resection;
performing, using the orientation parameters, bundle adjustment to generate refined orientation parameters of the camera;
wherein the bundle adjustment comprises an incremental bundle adjustment performed for a subset of images based at least in part on alignment information for the images of the image sequence; and
estimating a trajectory of the camera relative to the environment based at least in part on the refined orientation parameters by performing loop closure.

2. The computer-implemented method of claim 1, wherein the camera comprises a first camera sensor and a second camera sensor in a known orientation.

3. The computer-implemented method of claim 2, wherein the first camera sensor receives light from a first ultra-wide angle lens, and the second camera sensor receives light from a second ultra-wide angle lens.

4. The computer-implemented method of claim 2, further comprising:
performing a camera calibration on the first camera sensor to determine first intrinsic parameters of the first camera sensor; and
performing the camera calibration on the second camera sensor to determine second intrinsic parameters of the second camera sensor.

5. The computer-implemented method of claim 4, wherein the bundle adjustment refines at least one of the first intrinsic parameters and the second intrinsic parameters.

6. The computer-implemented method of claim 4, wherein the camera calibration is performed using the images of the image sequence without additional data.

7. The computer-implemented method of claim 1, wherein the first camera sensor and the second camera sensor provide a substantially 360 degree field of view around at least one axis of the camera.

8. The computer-implemented method of claim 1, wherein the orientation parameters comprise a position of a projection center of the camera and an orientation of the camera defined by a roll angle, a pitch angle, and a yaw angle.

9. The computer-implemented method of claim 1, further comprising:
subsequent to determining the orientation parameters of the camera using the sequential image resection, performing triangulation to reconstruct three-dimensional coordinates of points in the environment from multiple images of the image sequence taken from different viewpoints.

10. The computer-implemented method of claim 4, wherein the first intrinsic parameters of the first camera sensor and the second intrinsic parameters of the second camera sensor define an image format of the camera.

11. The computer-implemented method of claim 4, wherein the first intrinsic parameters of the first camera sensor and the second intrinsic parameters of the second camera sensor comprise at least one of a focal length, a pixel size, and an image origin.

12. The computer-implemented method of claim 1, wherein estimating the trajectory of the camera relative to the environment comprises:
computing a first sparse point cloud for the environment that is generated using the image sequence;
aligning the first sparse point cloud to a second sparse point cloud of the environment to generate an aligned sparse point cloud, wherein the aligning is based at least in part on a least squares optimization of a distance of known corresponding three-dimensional (3D) points, wherein the aligning comprises estimating parameters; and
realigning the images of the image sequence using the parameters estimated during the aligning.

13. The computer-implemented method of claim 1, further comprising performing a calibration on the camera to determine intrinsic parameters of the camera, wherein the bundle adjustment refines the intrinsic parameters and three-dimensional (3D) coordinates of points in a photogrammetric reconstruction.

14. A system comprising:
a camera to capture an image sequence of an environment as the camera moves relative to the environment; and
a processing system communicatively coupled to the camera, the processing system comprising:
a memory comprising computer readable instructions; and
a processing device for executing the computer readable instructions, the computer readable instructions controlling the processing device to:
extract and match features from images of the image sequence;
determine a relative orientation of the images of the image sequence;
determine orientation parameters of the camera using sequential image resection;
perform, using the orientation parameters, bundle adjustment to generate refined orientation parameters of the camera;
wherein the bundle adjustment comprises an incremental bundle adjustment performed for a subset of images based at least in part on alignment information for the images of the image sequence; and
estimate a trajectory of the camera relative to the environment based at least in part on the refined orientation parameters after performing loop closure.

15. The system of claim 14, wherein the camera comprises a first camera sensor and a second camera sensor, the first camera sensor is arranged in a known arrangement relative to the second camera sensor, the first camera sensor receives light from a first ultra-wide angle lens, and the second camera sensor receives light from a second ultra-wide angle lens.

16. The system of claim 15, wherein the processor executes further computer readable instructions to:
perform a camera calibration on each of the first camera sensor and the second camera sensor to determine first intrinsic parameters of the first camera sensor and second intrinsic parameters of the second camera sensor; and refine at least one of the first intrinsic parameters and the second intrinsic parameters using bundle adjustment.

17. The system of claim 16, wherein the first intrinsic parameters of the first camera sensor and the second intrinsic parameters of the second camera sensor define an image format of the camera.

18. The system of claim 14, wherein the orientation parameters comprise at least one of a position of a projection center of the camera and an orientation of the camera defined by a roll angle, a pitch angle, and a yaw angle.

19. The system of claim 14, wherein the trajectory of the camera relative to the environment is estimated by:
determining a first sparse point cloud for the environment using a first image from the image sequence;
determining a second sparse point cloud for the environment using a second image from the image sequence
aligning the first sparse point cloud to a second sparse point cloud of the environment to generate an aligned sparse point cloud using a least squares optimization of a distance of known corresponding three-dimensional (3D) points, to estimate alignment parameters; and
realigning the images of the image sequence using the estimated alignment parameters.

20. The system of claim 14, wherein the processor executes further processing instructions to:
perform a calibration on the camera to determine intrinsic parameters of the camera; and
refine the intrinsic parameters of the camera and three-dimensional (3D) coordinates of points in a photogrammetric reconstruction using bundle adjustment.
